(19) United States
(12) Patent Application Publication
(10) Pub. No.: US 2019/0138737 A1
(43) Pub. Date: May 9, 2019

(54) MAGNETIC PRIVACY SCREEN WITH SHUTTER

(71) Applicant: Stefan Leipold, Mount Vernon, NY (US)

(72) Inventor: Stefan Leipold, Mount Vernon, NY (US)

(21) Appl. No.: 16/182,211

(22) Filed: Nov. 6, 2018

Related U.S. Application Data
(60) Provisional application No. 62/582,238, filed on Nov. 6, 2017.

(51) Int. Cl. G06F 21/60; G06F 21/71; G03B 11/04; G02B 5/20; C09J 9/00; C09J 163/00

(52) U.S. Cl. CPC G06F 21/604; G06F 21/71; G03B 11/04; G06F 1/1656; C09J 9/00; C09J 163/00; G02B 5/20

(57) ABSTRACT

A privacy screen includes a screen that reduces a viewing angle of light transmitted through the screen. The privacy screen may include an adhesive that couples the cover to the screen. The adhesive may include a ferromagnetic material. The privacy screen may a shutter disposed proximal a longitudinal edge of the screen. The shutter may be disposed in a first configuration in which a through hole is exposed at a first location. The shutter may be disposed in a second configuration in which at least a part of the first location is occluded.

### CROSS REFERENCE TO RELATED APPLICATION

This application claims priority to U.S. Provisional Patent Application No. 62/582,238, filed Nov. 6, 2017, the disclosure of which is incorporated herein by reference in its entirety.

### BACKGROUND

The present disclosure relates to privacy screens for use with electronic devices.

As technology advances, the use of electronic devices is becoming evermore prevalent. Cell phones, laptops, and other devices are commonly used in public where others nearby can see contents of their screens. To promote privacy, a monitor filter or privacy screen may be used to limit the viewing range of the screen.

Privacy screens may be adhered to the screen by an adhesive, often resulting in a number of problems. First, the privacy screen must be applied evenly to reduce bubbling between the privacy screen and the surface of the monitor. Second, removal of the privacy screen leaves adhesive residue on the screen, which can be difficult to clean.

Privacy screens may also use auxiliary attachment members affixed to the display of an electronic device to engage the privacy screen. These devices require the user to carry extra equipment when they are mobile and the attachment members may created mechanical interference or other problems due to being permanently attached to the electronic device.

Based on the foregoing, there is a need in the art for a non-adhesive privacy screen that can be easily removed and reapplied to a mobile device screen. There is also a need to address privacy with respect to imaging devices that may be built into the electronic device.

### BRIEF SUMMARY

In an example, a privacy screen includes a screen, a cover and an adhesive. The screen is operable to reduce a viewing angle of light transmitted through the screen. The cover is operable to reduce abrasion to an electronic display. The adhesive is operable to couple the cover to the screen. The adhesive includes a ferromagnetic material.

In another example, a privacy screen includes a screen, a ferromagnetic component, and a shutter. The screen is operable to reduce a viewing angle of light transmitted through the screen. The ferromagnetic component is coupled to the screen. The shutter is disposed proximal a longitudinal edge of the screen. The shutter is operable to be disposed in a first configuration in which a through hole is exposed at a first location, and the shutter is operable to be disposed in a second configuration in which at least part of the first location is occluded.

### BRIEF DESCRIPTION OF THE DRAWINGS

FIG. 1 is a perspective view of a magnetic privacy screen.

FIG. 2 is a perspective view of a magnetic privacy screen.

FIG. 3A is a front view of a magnetic privacy screen in which a shutter is in a first position.

FIG. 3B is a front view of a magnetic privacy screen in which the shutter is in a second position.

FIG. 4A is a back view of a magnetic privacy screen in which a shutter is in a second position.

FIG. 4B is a back view of a magnetic privacy screen in which the shutter is in a first position.

FIG. 5 is a side view of a magnetic privacy screen.

FIG. 6 is an enlarged perspective view of a portion of a magnetic privacy screen.

FIG. 7 is an enlarged perspective view of a portion of a magnetic privacy screen.

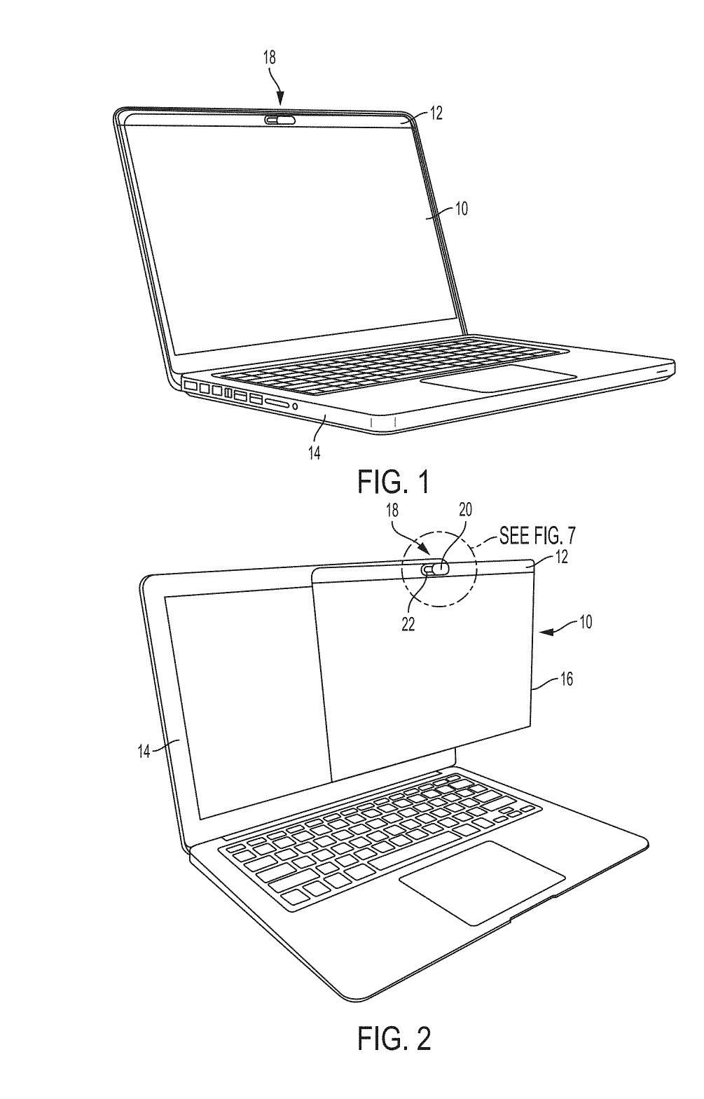

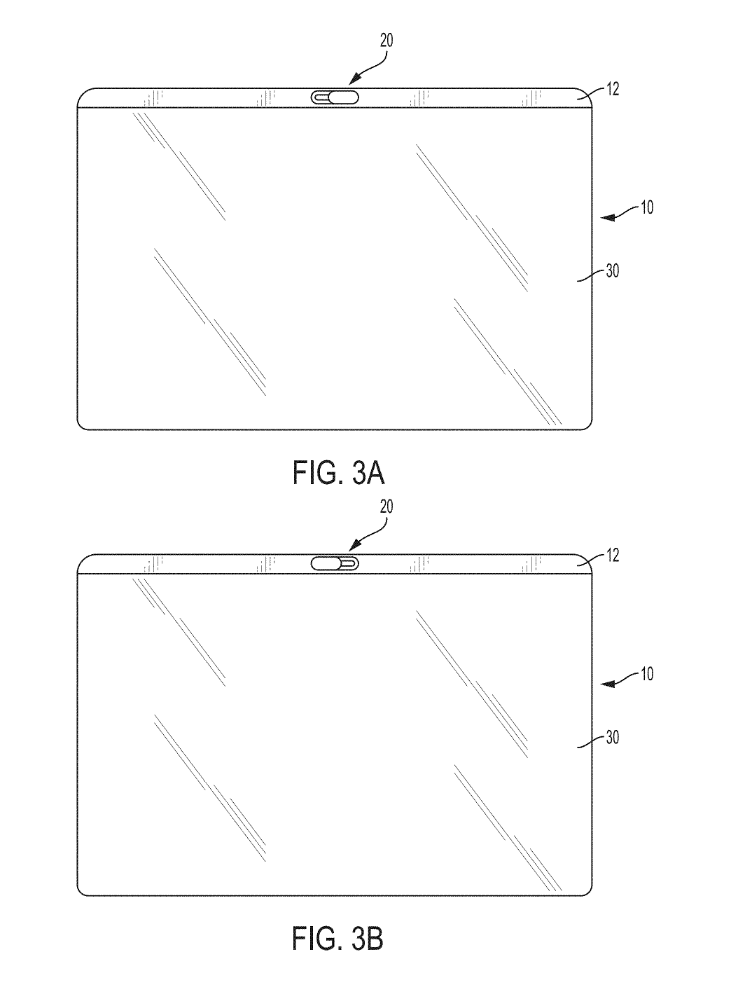

### DETAILED DESCRIPTION

Various aspects of privacy screens are described. It is to be understood, however, that the following explanation is merely exemplary. Accordingly, any number of reasonable and foreseeable modifications, changes, and/or substitutions are contemplated without departing from the spirit and scope of the present disclosure.

With reference to the figures, a privacy screen 10 includes one or more magnetic components 12 that releasably engage(s) the privacy screen 10 with an electronic device 14 allowing the user to easily apply and remove the privacy screen. The magnetic component 12 interacts with the magnets disposed in certain electronic device displays, allowing the privacy screen 10 to be retained on the screen of the electronic device 14 in a fixed position without the need for adhesives, external connecting members, or other auxiliary components for attachment.

The privacy screen 10 reduces the visible angle of an electronic display of the electronic device 14. The privacy screen 10 includes a screen 16 that skews light such that the viewing angle of the display of the electronic device is limited. In one example, the screen 16 allows light transmitted by the electronic device 14 to be emitted in a 60° viewing angle range. The privacy screen 10 may include a layer or other treatment to limit transmission of blue light. Limiting the transmission of light having wavelengths proximal to the blue spectrum may reduce eye strain and protect the user's eyes.

The magnetic component 12 preferably includes a ferromagnetic material. The ferromagnetic material may include magnets but this is not required. The ferromagnetic material may interact with the magnets already existing in a laptop display screen. In one example, the ferromagnetic material is a strip of material such as iron adhered to the screen 16. In another example, the ferromagnetic material includes a powdered material (such as iron powder), mixed in an adhesive and applied to the screen 16. The adhesive may be an epoxy or other glue. The amount of powdered material mixed with the glue may be selected such that the magnetic strength when placed in proximity to the magnets of the electronic device is sufficient to secure the privacy screen 10 to the electronic device 14.

In an embodiment, the magnetic component 12 provides for a magnetic flux density within a range of 2.28 and 100 gauss when in communication with the plurality of magnets. In a preferred embodiment, the magnetic component provides for a magnetic flux density within a range of 2.28 and 36.53 gauss when in communication with the plurality of magnets. Preferably, the magnetic flux density is sufficient to support the weight of the privacy screen 10 when coupled to the electronic device 14 while still permitting easy removal by the user.

The magnetic component 12 may include an aperture 18, positioned such that the functionality of a camera or other sensor of the electronic device 14 is not hindered by the magnetic component. The privacy screen 12 may include a shutter 20 to selectively block such a camera or other sensor of the electronic device. The shutter 20 may slide between left and right positions such that in one position, a through hole is exposed through which the camera or other sensor of the electronic device may be exposed, and in another position, the shutter 20 may block the camera or other sensor. The shutter 20 may be made of a material that is different than the material of the screen 16 such as plastic.

In one example, the shutter 20 includes a frame portion 22 to which the shutter 20 is slideably engaged. An outer dimension of the shutter 20 with the frame portion according to a preferred embodiment may be about 10 mm tall by 20 mm wide and less than 1 mm thick.

In an example, the magnetic component 12 may extend along an entire longitudinal edge of the privacy screen 10. In another example, the magnetic component 12 may extend along an entire perimeter of the privacy screen 10. The magnetic component 12 may include a plurality of magnetic components.

The privacy screen 12 has a front side 30 and a back side 32. The back side 32 may contact the display of the electronic device 14 and the front side 30 may face a user. To reduce abrasion to the display of the electronic device 14, preferably the screen 16 is made of a soft material such as a soft polyethylene terephthalate (PET), however other semi-crystalline resins may be used. The screen 16 may be rigid, such that the privacy screen 10 is in close contact with the display surface of the electronic device 14. The coating of the privacy screen may be anti-reflective and 3H scratch resistant. The magnetic component 12 may be disposed on one or both sides of the screen.

The selective transparency of the screen 16 may be provided by an anti-reflective coating or structure. For example, micro louvers, anti-reflective coatings, or other privacy components may permit light to pass on a vector perpendicular to the plane of the screen. In this manner, someone standing past the visible angle allowed by the micro louvers will not be able to see the display's emitted light. In a preferred embodiment, the privacy screen 10 allows for a 60° viewing angle.

The privacy screen 10 may include an abrasion resistance element to reduce the risk of scratching or otherwise damaging the electronic display when in use. In an example, the abrasion resistance element is provided as a cover to the magnetic component 12. The abrasion resistance element may include leather, vinyl, synthetic leather, fabric.

In one particular example, the abrasion resistance element is provided by a leather (or similar synthetic material) strip fixed to the screen 16 using an adhesive impregnated with the ferromagnetic material. The ferromagnetic adhesive may be sprayed onto the abrasion resistance element, which may then be positioned on the screen 16 to assemble the abrasion resistance element to the screen 16. An advantage of this example is simpler manufacturing as the same step that applies the abrasion resistance element may also provide the magnetic component 12. The ferromagnetic adhesive may provide magnetic component 12 itself such that an additional element is not needed.

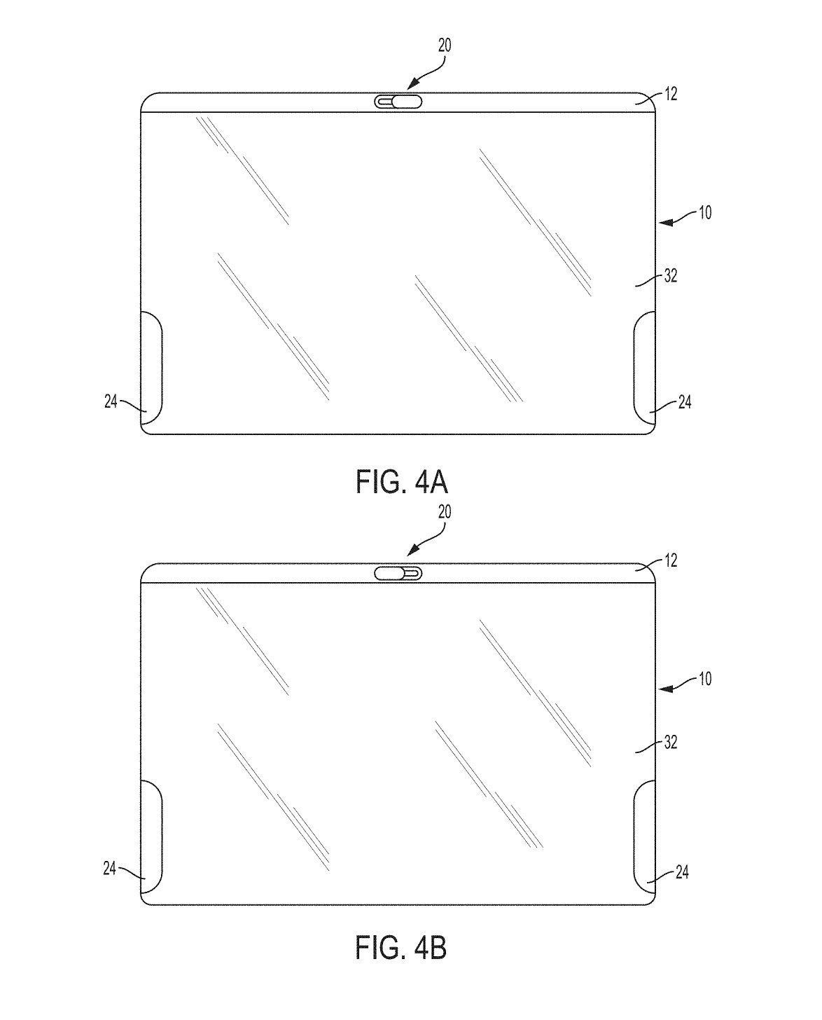

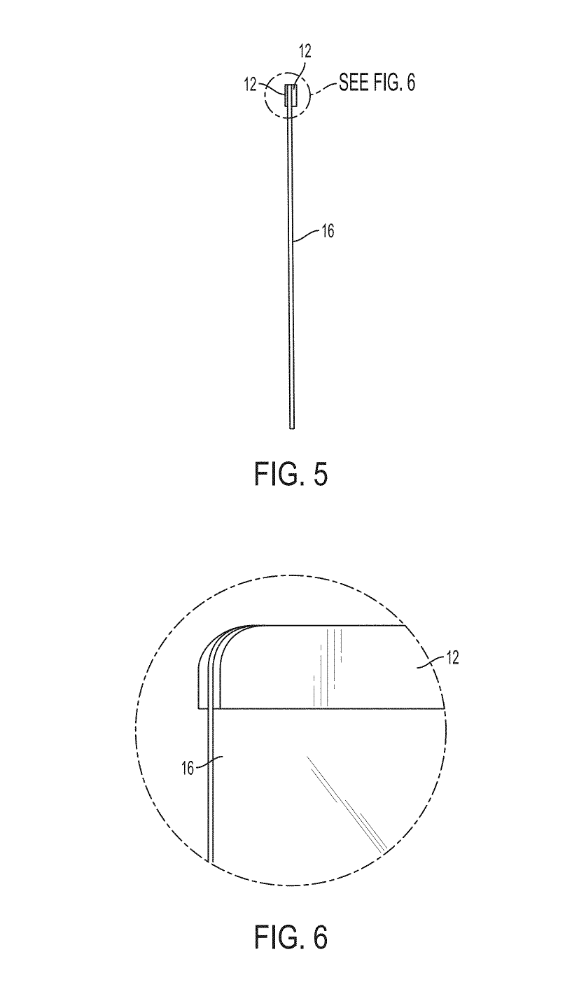

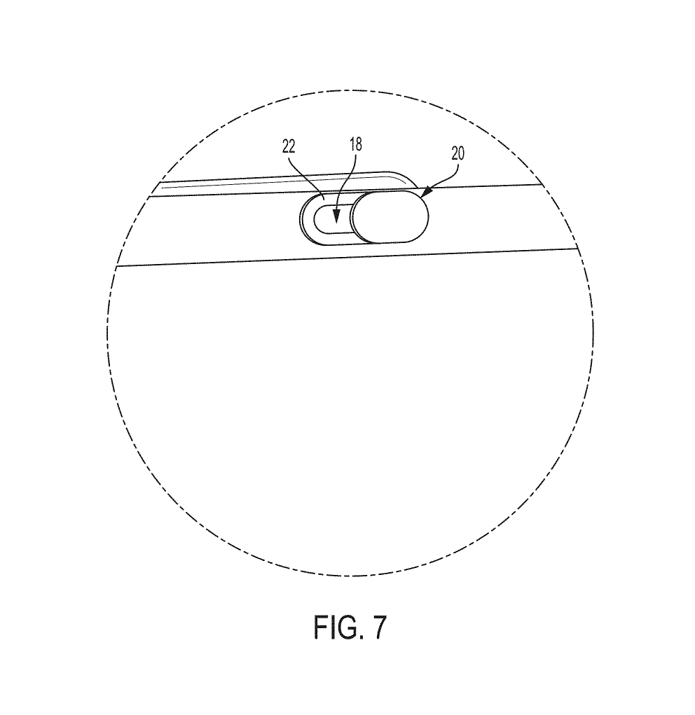

In an example, the back side 32 of the privacy screen 10 may include bumpers 24 proximal a longitudinal edge (or respectively both longitudinal edges) adjacent the edge associated with the magnetic component 12 (e.g., as shown in FIG. 4). The bumpers 24 preferably have a thickness approximately the same as the thickness of the magnetic component 12. The bumpers 24 may limit bending of the screen 16 and assist in limiting the screen 10 from sliding downwardly. Thus, the magnetic force required to hold the screen 10 to the electronic device 14 may be reduced when the bumpers 24 are included. In a preferred example, the bumpers 24 are made of a material that provides friction with respect to an adjacent surface of the electronic device 14 such as silicon. The bumpers 24 may be adhered to the screen 16 by double sided tape, an adhesive, or may be formed directly on the screen 16. The bumpers 24 are preferably located on the short sides of the screen 16 as there may be more bezel available in this region such that there is reduced interference with viewing the electronic display. It will be appreciated that the bumpers 24 may also be located anywhere on the screen 16, preferably proximal to a periphery of the screen 16.

In an embodiment the privacy screen has a generally rectangular shape dimensioned to correspond to a generally rectangular display of an electronic device. In a preferred embodiment, one or more magnetic components are positioned on a length side of the rectangular shape of the privacy screen.

In an alternate embodiment, one or more magnetic components are disposed within the material of the privacy screen, for example in adhesive disposed about a perimeter of the screen that adheres layers of the privacy screen together, allowing for the surface of the back side of the privacy screen to be in direct contact with the screen.

Although the invention(s) is/are described herein with reference to specific embodiments, various modifications and changes can be made without departing from the scope of the disclosure. Accordingly, the specification and figures are to be regarded in an illustrative rather than a restrictive sense, and all such modifications are intended to be included within the scope of the present disclosure. The breadth and scope of the present disclosure should not be limited by any of the above-described exemplary embodiments. Any benefits, advantages, or solutions to problems that are described herein with regard to specific embodiments are not intended to be construed as a critical, required, or essential feature or element of any or all the claims.

I claim:

1. A privacy screen, comprising:
a screen operable to reduce a viewing angle of light transmitted through the screen;
a cover operable to reduce abrasion to an electronic display; and
an adhesive operable to couple the cover to the screen, the adhesive including a ferromagnetic material.

2. The privacy screen of claim 1, wherein the ferromagnetic material includes iron powder.

3. The privacy screen of claim 1, wherein the adhesive includes epoxy mixed with a ferromagnetic powder.

4. The privacy screen of claim 1, wherein a magnetic flux density of the ferromagnetic material is in the range of 2.28 to 100 gauss when in communication with one or more magnets of an electronic display.

5. The privacy screen of claim 1, wherein the screen is operable to limit transmission of blue light.

6. The privacy screen of claim 1, wherein the cover includes at least one of polyethylene terephthalate, leather and synthetic leather.

7. The privacy screen of claim 1, wherein
the cover is disposed proximal a first longitudinal edge of the screen, and
the screen includes a bumper disposed proximal a second longitudinal edge of the screen, the second longitudinal edge being adjacent to the first longitudinal edge.

8. The privacy screen of claim 7, wherein the bumper includes silicone.

9. The privacy screen of claim 1, further comprising a shutter disposed proximal a longitudinal edge of the screen, the shutter being operable to be disposed in a first configuration in which a through hole is exposed at a first location, and the shutter being operable to be disposed in a second configuration in which at least part of the first location is occluded.

10. A privacy screen, comprising:
a screen operable to reduce a viewing angle of light transmitted through the screen;
a ferromagnetic component coupled to the screen; and
a shutter disposed proximal a longitudinal edge of the screen, the shutter being operable to be disposed in a first configuration in which a through hole is exposed at a first location, and the shutter being operable to be disposed in a second configuration in which at least part of the first location is occluded.

11. The privacy screen of claim 10, further comprising a bumper disposed proximal a second longitudinal edge of the screen, the second longitudinal edge being adjacent the longitudinal edge.

12. The privacy screen of claim 11, wherein the bumper includes silicone.

13. The privacy screen of claim 10, further comprising a ferromagnetic element disposed proximal the longitudinal edge of the screen.

14. The privacy screen of claim 13, wherein the shutter is disposed at least partially in the ferromagnetic element.

15. The privacy screen of claim 13, further comprising a cover disposed over the ferromagnetic element, the cover being operable to reduce abrasion to an electronic device.

16. The privacy screen of claim 15, further comprising an adhesive operable to couple the cover to the screen.

17. The privacy screen of claim 16, wherein the adhesive includes a ferromagnetic material that provides the ferromagnetic element.

18. The privacy screen of claim 17, wherein the ferromagnetic material includes ferromagnetic powder, and the ferromagnetic material includes the adhesive mixed with the ferromagnetic powder.

19. The privacy screen of claim 17, wherein the ferromagnetic powder includes iron powder.
